(19) United States
(12) Patent Application Publication
(10) Pub. No.: US 2012/0313833 A1
(43) Pub. Date: Dec. 13, 2012

(54) APERTURE ANTENNA

(75) Inventors: Shih-Kai Lin, Taipei City (TW); Bing-Syun Li, Taipei City (TW); Yi-Cheng Lin, Taipei City (TW)

(73) Assignee: NATIONAL TAIWAN UNIVERSITY, Taipei (TW)

(21) Appl. No.: 13/566,957

(22) Filed: Aug. 3, 2012

Related U.S. Application Data
(62) Division of application No. 12/536,322, filed on Aug. 5, 2009.

(30) Foreign Application Priority Data
Feb. 2, 2009 (TW) TW98103203

(51) Int. Cl. H01Q 13/10

(52) U.S. Cl. 343/767

(57) ABSTRACT

An aperture antenna for transmitting a circularly polarized signal is provided. The aperture antenna includes an antenna substrate, a feed conductor and an antenna ground layer. The feed conductor is microstrip-fed or coplanar-wave-guide-fed. The antenna ground layer has an aperture, the aperture has a feed portion, a signal turning point, a first edge and a second edge, the first edge connects the feed portion to the signal turning point in a first direction, and the second edge connects the feed portion to the signal turning point in a second direction, the first direction is opposite to the second direction. When the aperture antenna transmits the circularly polarized signal, a traveling wave travels on the first edge, and at least one standing wave is formed on the second edge.

### CROSS REFERENCE TO RELATED APPLICATIONS

This Application claims priority of Taiwan Patent Application No. 098103203, filed on Feb. 2, 2009, the entirety of which is incorporated by reference herein.

### BACKGROUND OF THE INVENTION

1. Field of the Invention

The present invention relates to an antenna, and in particular relates to an aperture antenna transmitting a circularly polarized signal.

2. Description of the Related Art

FIGS. 1a and 1b show a conventional antenna 1 for transmitting a circularly polarized signal. The antenna 1 comprises a substrate 10, a radiator 20 and a ground layer 30. The substrate 10 comprises a first surface and a second surface. The first surface is opposite to the second surface. The radiator 20 is disposed on the first surface. The ground layer 30 is disposed on the second surface. The radiator 20 is rectangular, and comprises a beveled corner 21. FIG. 1b is a sectional view along direction I-I of FIG. 1, wherein a signal line 41 is electrically connected to the radiator 20 passing through the substrate 10.

A conventional antenna provides an axial ratio bandwidth of about 3˜5%, which does not satisfy wideband circularly polarized signal transmission.

### BRIEF SUMMARY OF THE INVENTION

A detailed description is given in the following embodiments with reference to the accompanying drawings.

An aperture antenna for transmitting a circularly polarized signal is provided. The aperture antenna includes an antenna substrate, a feed conductor and an antenna ground layer. The antenna substrate has a first surface and a second surface. The feed conductor is disposed on the first surface. The antenna ground layer is disposed on the second surface, wherein the antenna ground layer has an aperture, the aperture has a feed portion, a signal turning point, a first edge and a second edge, the first edge connects the feed portion to the signal turning point in a first direction, and the second edge connects the feed portion to the signal turning point in a second direction, the first direction is opposite to the second direction, and when the aperture antenna transmits the circularly polarized signal, a traveling wave travels on the first edge, and at least one standing wave is formed on the second edge.

The aperture antennas of the embodiments provide improved axial ratio bandwidth, which can transmit a wideband circularly polarized signal.

### BRIEF DESCRIPTION OF THE DRAWINGS

The present invention can be more fully understood by reading the subsequent detailed description and examples with references made to the accompanying drawings, wherein:

FIG. 1a shows a conventional antenna for transmitting a circularly polarized signal;

FIG. 1b is a sectional view along direction I-I of FIG. 1;

FIG. 2 shows an aperture antenna of a first embodiment of the invention;

FIG. 3a is a top view of the aperture antenna of the first embodiment;

FIG. 3b is a bottom view of the aperture antenna of the first embodiment;

FIG. 4 shows a surface current of the aperture antenna of the first embodiment;

FIG. 5 shows a detailed structure of the aperture antenna of the first embodiment;

FIG. 6 shows the transmission of the aperture antenna of the first embodiment;

FIG. 7 shows an aperture antenna of a second embodiment of the invention;

FIG. 8 is a top view of the aperture antenna of the second embodiment;

FIG. 9 shows a detailed structure of the aperture antenna of the second embodiment;

FIG. 10 shows the transmission of the aperture antenna of the second embodiment; and

FIG. 11 shows an aperture antenna of a third embodiment of the invention.

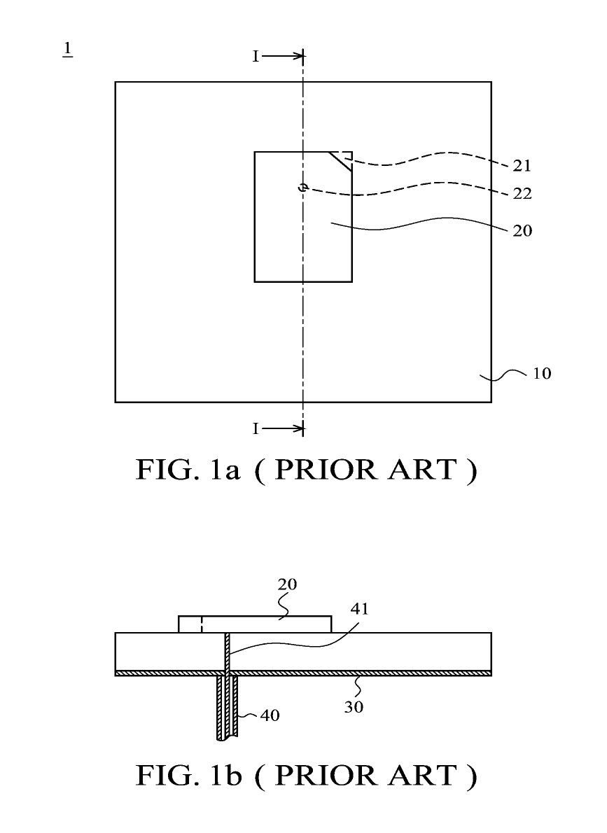

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

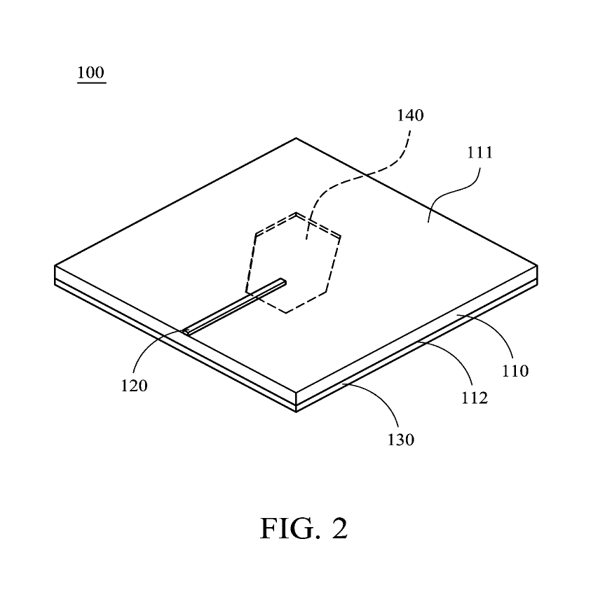

FIG. 2 shows an aperture antenna 100 of a first embodiment of the invention for transmitting a circularly polarized signal. The aperture antenna 100 comprises an antenna substrate 110, a feed conductor 120 and an antenna ground layer 130. The antenna substrate 110 comprises a first surface 111 and a second surface 112. The feed conductor 120 is disposed on the first surface 111 as a microstrip-fed. The antenna ground layer 130 is disposed on the second surface 112. The antenna ground layer 130 has an aperture of 140.

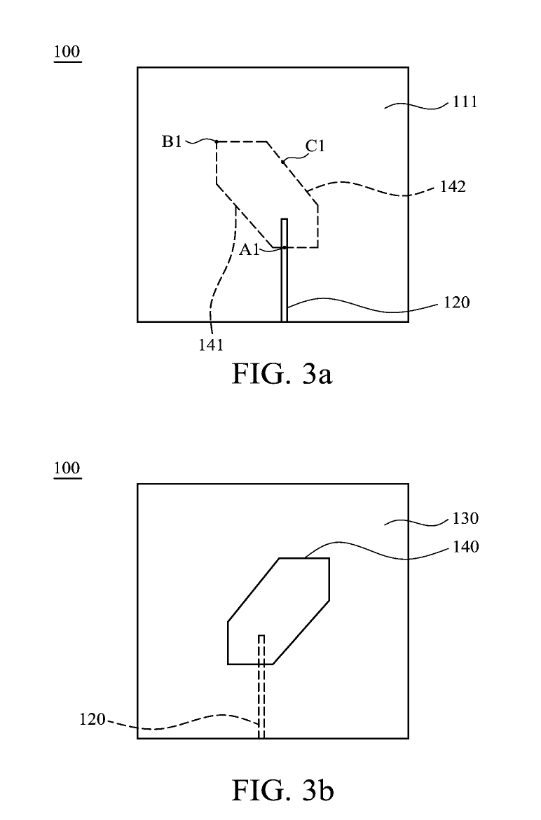

FIG. 3a is a top view of the aperture antenna 100, and FIG. 3b is a bottom view of the aperture antenna 100. With reference to FIG. 3a, the aperture 140 has a feed portion A1, a signal turning point B1, a first edge 141 and a second edge 142. The first edge 141 connects the feed portion A1 to the signal turning point B1 in a first direction (clockwise), and the second edge 142 connects the feed portion A1 to the signal turning point B1 in a second direction (counterclockwise). The first direction is opposite to the second direction. When the aperture antenna 100 transmits the circularly polarized signal, a traveling wave travels on the first edge 141. At least one standing wave stands on the second edge 142. In the embodiment of the invention, the signal turning point is defined as a point between the first edge and the second edge, the traveling wave travels on the first edge, and the standing wave stands on the second edge.

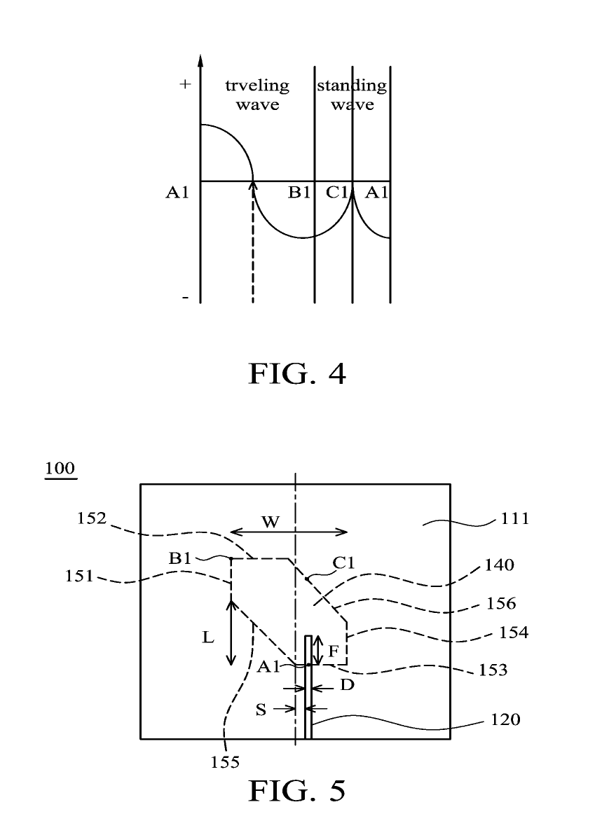

In the first embodiment of the invention, a null point C1 is formed on the second edge 142, and two standing waves are formed on the second edge 142. A first standing wave is formed between the feed portion A1 and the null point C1, and a second standing wave is formed between null point C1 and the signal turning point B1. FIG. 4 shows a surface current of the aperture antenna 100.

With reference to FIG. 5, the aperture antenna 140 is hexagon, comprising a first side 151, a second side 152, a third side 153, a fourth side 154, a fifth side 155 and a sixth side 156. The first side 151 is connected to the second side 152, the first side 151 is perpendicular to the second side 152, the third side 153 is connected to the fourth side 154, the third side 153 is perpendicular to the fourth side 154, the fifth side 155 connects the first side 151 to the third side 153, the sixth side 156 connects the second side 152 to the fourth side 154, and the fifth side 155 is parallel to the sixth side 156. A length of the first side 151 is equal to a length of the second side 152. A length of the fifth side 155 is equal to a length of the sixth side 156. The length of the first side 151 is equal to the length of the third side 153, and the length of the third side 153 is equal to the length of the fourth side 154. The signal turning point B1 is located on a connection point of the first side 151 and the second side 152, and the feed portion A1 is located on the third side 513. The feed conductor 120 is perpendicular to the third side 153, and correspondingly passing the feed portion A1. The null point C1 is located on the sixth side 156. The first edge extends from the feed portion A1, passing the third side 153, the fifth side 155 and the first side 151 to the signal turning point B1. The second edge extends from the feed portion A1, passing the third side 153, the fourth side 154, the sixth side 156 and the second side 152 to the signal turning point B1.

In a modified embodiment, the length of the first side 151 is equal to the length of the third side 153, the length of the second side 152 is equal to the fourth side 154, and the length of the third side 153 is not equal to the fourth side 154.

In the first embodiment, the aperture has an aperture side length W=24 mm, a feed length F=8.9 mm, a beveled length L=13 mm, and a feed conductor width D=0.6 mm The feed conductor is held a distance S=3.9 away from a point where the third side 153 connects the fifth side 155. In the first embodiment, an operation frequency of the aperture antenna can be modified by changing the aperture side length. The return loss matching of the aperture antenna can be modified by changing the feed length of the feed conductor. The frequency of the return loss matching and the axial ratio can be modified by changing the position of the feed conductor. In the first embodiment, the hexagon aperture is formed by cutting of the opposite corners of a square to transmit circularly polarized signal.

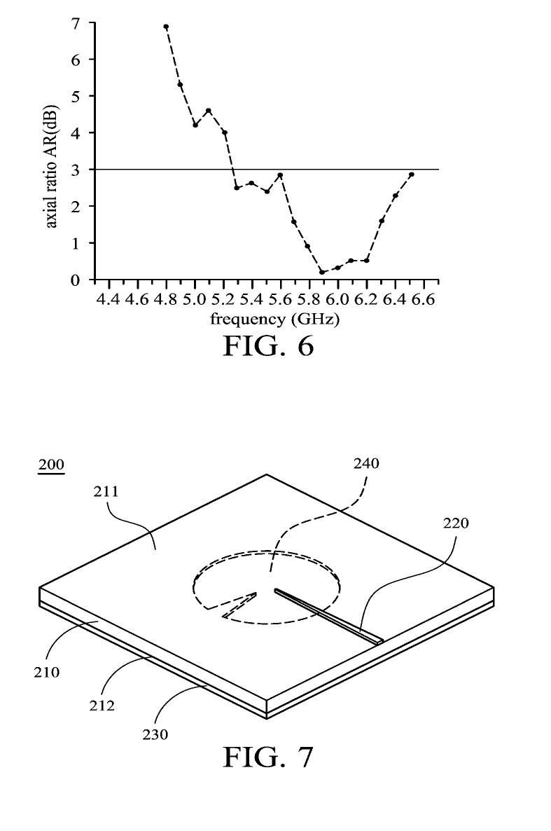

FIG. 6 shows the transmission of the aperture antenna of the first embodiment, wherein the aperture antenna of the first embodiment provides an axial ratio bandwidth of about 18˜20%, which can transmit a wideband circularly polarized signal.

FIG. 7 shows an aperture antenna 200 of a second embodiment of the invention for transmitting a circularly polarized signal. The aperture antenna 200 comprises an antenna substrate 210, a feed conductor 220 and an antenna ground layer 230. The antenna substrate 210 comprises a first surface 211 and a second surface 212. The feed conductor 220 is disposed on the first surface 211. The antenna ground layer 230 is disposed on the second surface 212. The antenna ground layer 230 has an aperture 240.

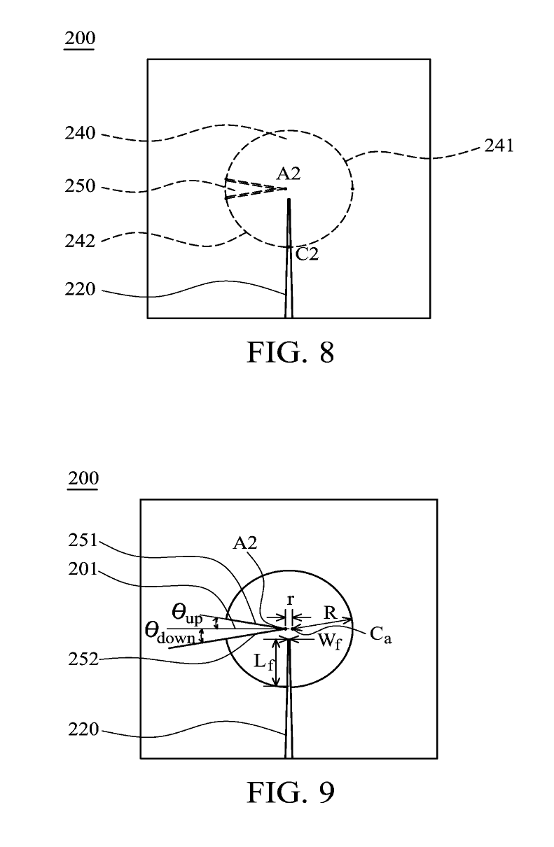

FIG. 8 is a top view of the aperture antenna 200. With reference to FIG. 8, the aperture 240 has a feed portion C2, a signal turning point A2, a first edge 241 and a second edge 242. The first edge 241 connects the feed portion C2 to the signal turning point A2 in a first direction (counterclockwise), and the second edge 242 connects the feed portion C2 to the signal turning point A2 in a second direction (clockwise). The first direction is opposite to the second direction. When the aperture antenna 200 transmits the circularly polarized signal, a traveling wave travels on the first edge 241. A standing wave stands on the second edge 242. The circularly polarized radiation property of the aperture antenna 200 can be modified by changing the length of the first edge 241. The return loss matching of the aperture antenna 200 can be modified by changing the length of the second edge 242.

In the second embodiment, the aperture 240 is circular, and has a sector notch 250 formed on a circumference of the aperture 240. The signal turning point A2 is located on the tip of the sector notch 250.

With reference to FIG. 9, the aperture antenna 200 further comprises a base line 201, the base line passes the signal turning point A2 and a center Cₐ of the aperture, the sector notch has a first side 251 and a second side 252, the first side 251 is located on the first edge 241, the second side 252 is located on the second edge 242, a first included angle θᵤₚ is formed between the first side 251 and the base line 201, and a second included angle θ_{down} is formed between the second side 252 and the base line 201. The first included angle θᵤₚ can be changed to modify a return loss matching of the aperture antenna. The second included angle θ_{down} can be changed to modify a frequency of the circularly polarized signal and a purity thereof. The return loss matching and axial ratio bandwidth can be modified by changing a distance r between the signal turning point A2 and the center Cₐ of the aperture.

In one embodiment, the feed conductor 220 extends toward the center Cₐ of the aperture 240, and the length of the first edge 242 is equal to a quarter of a circumference length of the aperture 240. The circumference length of the aperture is about 3λₒ, wherein λₒ is a vacuum wave length of a central frequency of the circularly polarized signal. The diameter of the aperture is about λd_{g}, wherein λ_{g} is a guide wave length of the circularly polarized signal.

In one embodiment, the first included angle θᵤₚ is 10°, and the second included angle θ_{down} is 10°. The width W_{f} of the feed conductor is 0.3 mm The feed length L_{f} of the feed conductor is 11 mm The distance between the signal turning point A2 and the center Cₐ of the aperture is 3 mm, and a radius R of the aperture is 14 mm.

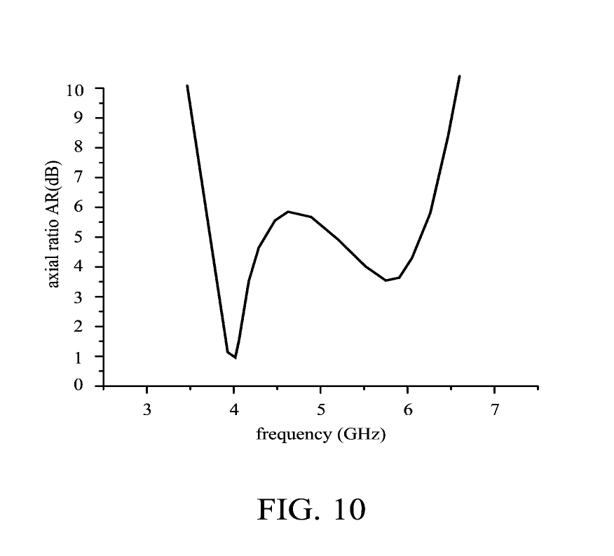

FIG. 10 shows the transmission of the aperture antenna of the second embodiment, wherein the aperture antenna of the first embodiment provides an axial ratio bandwidth of about 7.6%, which is better than transmission of prior art.

In the embodiments of the invention the circularly polarized signal travels in a right or left spin path. However, the invention is not limited thereto.

The transmission data disclosed in the embodiments is data gathered under a single radiation condition. The aperture antennas of the embodiments can be utilized with a reflector, a cavity back element or an electromagnetic band gap element to provide a single radiation property. The reflector and cavity back technologies are mature technologies, and thus related description is omitted.

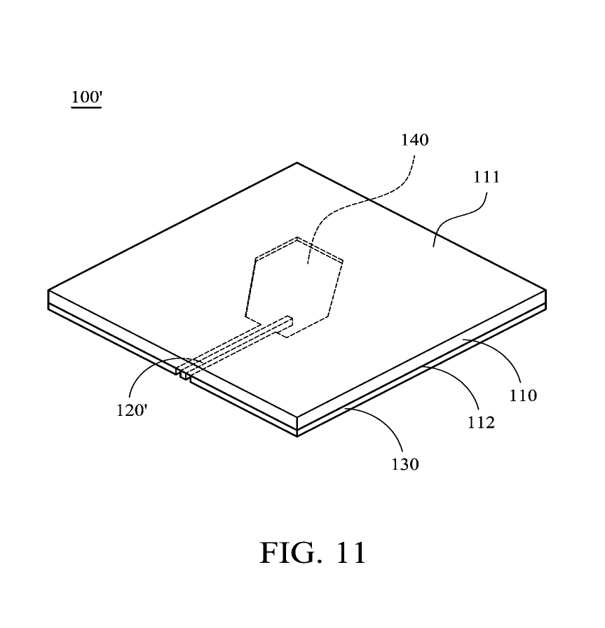

FIG. 11 shows an aperture antenna 100′ of the third embodiment of the invention, wherein a feed conductor 120′ is disposed on the second surface 112 as a coplanar-wave-guide-fed, and passing the feed portion.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An aperture antenna for transmitting a circularly polarized signal, comprising:
an antenna substrate, having a first surface and a second surface;
an antenna ground layer, disposed on the second surface, wherein the antenna ground layer has an aperture, the aperture has a feed portion, a signal turning point, a first edge and a second edge, the first edge connects the feed portion to the signal turning point in a first direction, and the second edge connects the feed portion to the signal turning point in a second direction, the first direction is opposite to the second direction, and when the aperture antenna transmits the circularly polarized signal, a traveling wave travels on the first edge, and at least one standing wave is formed on the second edge; and
a feed conductor, passing the feed portion and corresponding to aperture,
wherein the aperture is hexagon.

2. (canceled)

3. The aperture antenna as claimed in claim 1, wherein the aperture further has a first side, a second side, a third side, a fourth side, a fifth side and a sixth side, wherein the first side is connected to the second side, the first side is perpendicular to the second side, the third side is connected to the fourth side, the third side is perpendicular to the fourth side, the fifth side connects the first side to the third side, the sixth side connects the second side to the fourth side, and the fifth side is parallel to the sixth side.

4. The aperture antenna as claimed in claim 3, wherein a length of the first side is equal to a length of the second side.

5. The aperture antenna as claimed in claim 4, wherein a length of the fifth side is equal to a length of the sixth side.

6. The aperture antenna as claimed in claim 5, wherein the length of the first side is equal to the length of the third side, and the length of the third side is equal to the length of the fourth side.

7. The aperture antenna as claimed in claim 3, wherein the signal turning point is located on a connection point of the first side and the second side, and the feed portion is located on the third side.

8. The aperture antenna as claimed in claim 7, wherein the first edge extends from the feed portion, passing the third side, the fifth side and the first side to the signal turning point.

9. The aperture antenna as claimed in claim 7, wherein the second edge extends from the feed portion, passing the third side, the fourth side, the sixth side and the second side to the signal turning point.

10. The aperture antenna as claimed in claim 7, wherein the aperture further has a null point, the null point is located on the sixth side, a first standing wave is formed between the feed portion and the null point, and a second standing wave is formed between the null point and the signal turning point.

11-19. (canceled)

20. The aperture antenna as claimed in claim 1, wherein feed conductor is a microstrip-fed formed on the first surface.

21. The aperture antenna as claimed in claim 1, wherein feed conductor is a coplanar-wave-guide-fed formed on the second surface.
